(19) United States
(12) Patent Application Publication
(10) Pub. No.: US 2023/0073490 A1
(43) Pub. Date: Mar. 9, 2023

(54) ASSISTANCE APPARATUS, TOOL DEVICE AND METHOD OF OPERATING A TOOL DEVICE

(71) Applicant: FESTOOL GMBH, Wendlingen (DE)

(72) Inventors: Christoph DIETER, Gomaringen (DE); Moritz KELLER, Fellbach (DE); Peter SEILER, Dornstadt (DE)

(73) Assignee: FESTOOL GMBH, Wendlingen (DE)

(21) Appl. No.: 17/769,510

(22) PCT Filed: Jul. 31, 2020
(86) PCT No.: PCT/EP2020/071648

§ 371 Date: Apr. 15, 2022

(30) Foreign Application Priority Data
Oct. 17, 2019 (DE) 10 2019 216 038.7

(51) Int. Cl. B25F 5/02; B25F 5/00

(52) U.S. Cl. CPC B25F 5/026; B25F 5/00

(57) ABSTRACT

An assistance apparatus for a hand-held tool apparatus, in particular a screwing and/or drilling apparatus, that includes a fastening unit for detachable fastening of the assistance apparatus to the tool apparatus, and an electrical assistance device, which is designed to provide an assistance function for supporting a machining operation of the tool apparatus. The electrical assistance device includes an assistance apparatus communication unit for communication with the tool apparatus.

The invention relates to an assistance apparatus for a hand-held tool apparatus, in particular a screwing and/or drilling apparatus. The assistance apparatus comprises a fastening unit for detachable fastening of the assistance apparatus to the tool apparatus, and an electrical assistance device which is designed to provide an assistance function for supporting a machining operation of the tool apparatus. The machining operation is, for example, a drilling operation or a screwing operation. The assistance apparatus is designed, for example, as a handle module. The assistance apparatus is expediently not a tool apparatus energy storage—that is, not an energy storage for operating the tool apparatus. In particular, the assistance device is not a tool apparatus battery.

DE 20 2008 016 901 U1 describes an auxiliary handle for manually controlled work machines. Inside the handle there is an electronic angle measuring device.

EP 1 036 635 A2 describes a line finder with a sensor system, electronics, display and voltage source integrated in a front handle of a drilling machine.

It is an object of the invention to improve the assistance device.

The object is solved by an assistance apparatus according to claim 1. The electrical assistance device of the assistance apparatus comprises an assistance apparatus communication unit for communication with the tool apparatus.

By means of the assistance apparatus communication unit, it is possible to exchange information between the assistance apparatus and the tool apparatus. This can improve the interaction between the assistance apparatus and the tool apparatus, so that the assistance apparatus can provide better overall support for the machining operation performed with the tool apparatus.

The invention further relates to a tool device comprising the assistance apparatus and the hand-held tool apparatus.

The invention further relates to a method of operating the tool device, comprising the steps of: Attaching the first assistance apparatus to the tool apparatus, and performing a machining operation with the tool apparatus with assistance from the assistance function of the first assistance apparatus.

Further exemplary details as well as exemplary embodiments are explained below with reference to the figures. Thereby shows

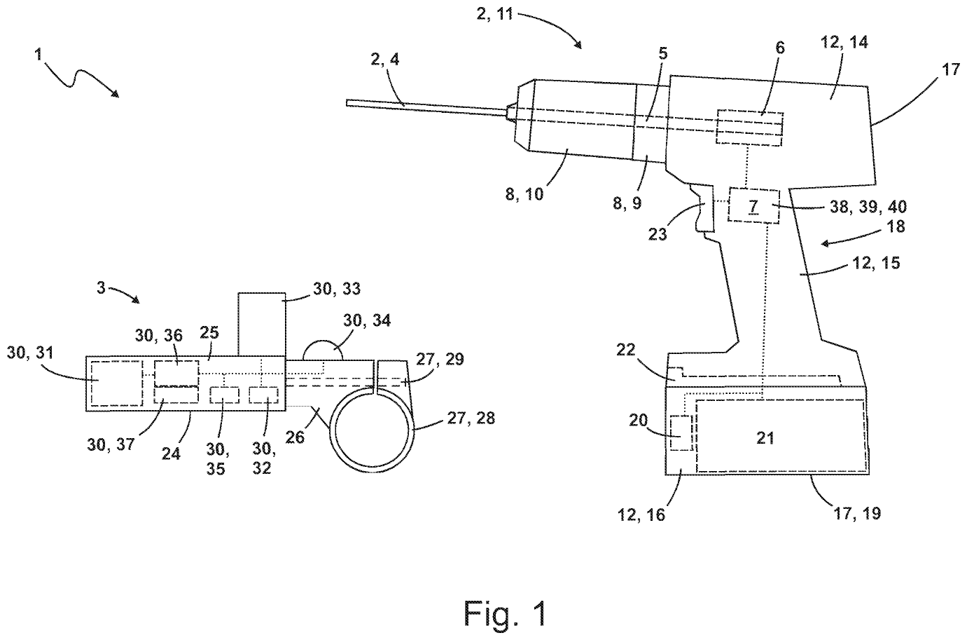

FIG. 1 a schematic representation of a tool device comprising a hand-held tool apparatus and an assistance apparatus,

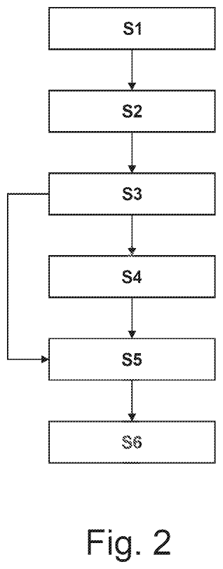

FIG. 2 a flowchart of a method for operating a tool device,

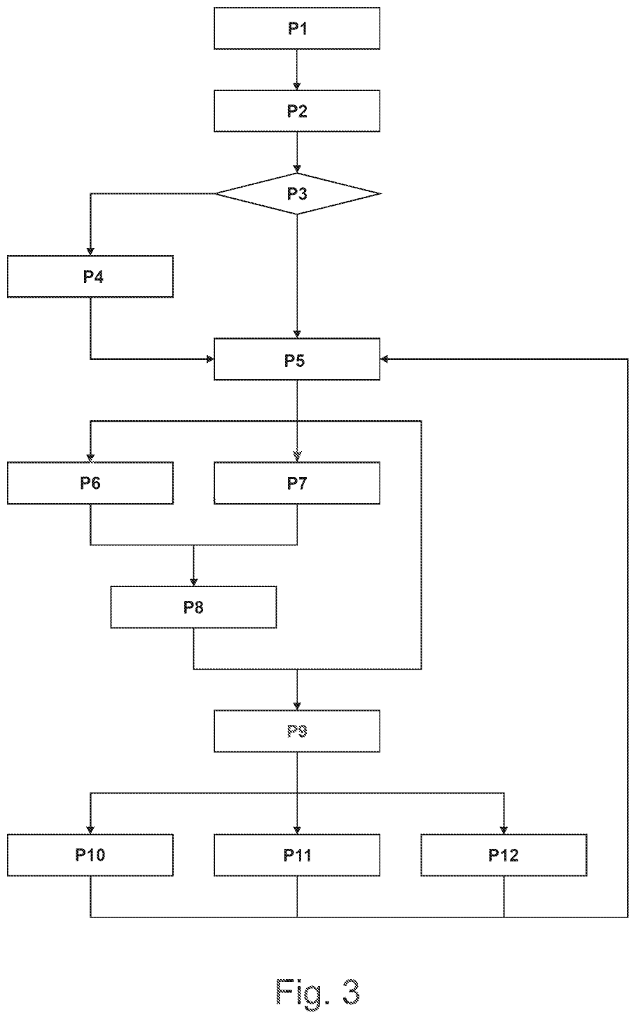

FIG. 3 a flowchart of a further method for operating a tool device,

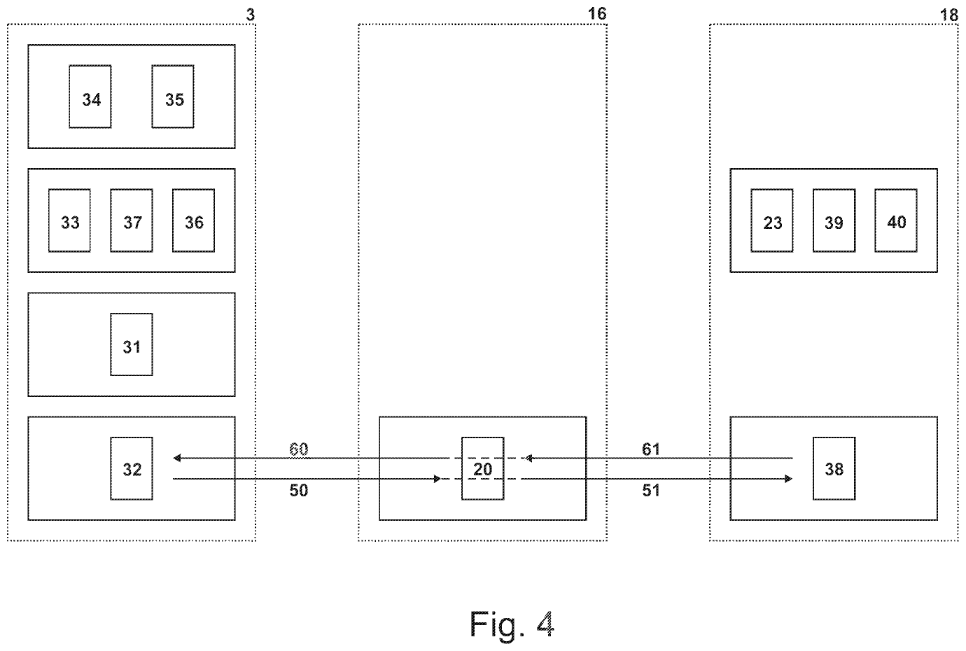

FIG. 4 a block diagram illustrating communication between an assistance apparatus, an energy storage section, and a working section of a tool apparatus.

FIG. 1 shows a tool device 1 comprising a hand-held tool apparatus 2 and an assistance apparatus 3. The hand-held tool apparatus 2 is preferably a screwing and/or a drilling apparatus. Exemplarily, the hand-held tool apparatus 2 is a hand-held drill, in particular a cordless drill, or a hand-held cordless screwdriver. Expediently, the tool apparatus 2 is a cordless drill-screw apparatus, i.e. it can both drill and screw.

The tool device 1 serves as an exemplary application environment for the assistance apparatus 3. According to a possible embodiment, the assistance apparatus 3 can also be provided on its own—i.e. in particular without the tool apparatus 2.

The assistance apparatus 3 comprises a fastening unit 27 for detachably attaching the assistance apparatus 3 to the tool apparatus 2. The assistance apparatus 3 further comprises an electric assistance device 30 configured to provide an assistance function for assisting a machining operation of the tool apparatus 2. The electrical assistance device 30 comprises an assistance apparatus communication unit 32 for communicating with the tool apparatus 2.

Further exemplary details are explained below.

First of all, regarding the assistance apparatus 3:

The assistance apparatus 3 can be designed as a handle module, in particular as an auxiliary-handle module. The assistance apparatus 3 is in particular an attachment device, preferably an auxiliary device, for the tool apparatus 2. The assistance apparatus is in particular designed as an assistance module.

According to one possible embodiment, the assistance apparatus 3 is a self-sufficient device that can be operated independently of—i.e. in particular also without—the tool apparatus 2. In particular, the assistance apparatus 3 can also be operated in a state removed from the tool apparatus 2.

Exemplarily, the assistance apparatus 3 has an elongated shape and extends along an assistance apparatus longitudinal axis. The assistance apparatus 3 comprises an assistance apparatus handle section 25 and a fastening section 26 adjoining the assistance apparatus handle section 25, in particular in the axial direction of the assistance apparatus longitudinal axis. The assistance apparatus handle section 25 is designed as a handle. Expediently, the assistance apparatus handle section 25 has a cylindrical shape and is aligned in particular parallel to the assistance apparatus longitudinal axis. The fastening section 26 comprises the fastening unit 27 and is arranged in particular on a face side of the assistance apparatus handle section 25.

The fastening unit 27 serves to provide a mechanical connection between the assistance apparatus 3 and the tool apparatus 2. The fastening unit 27 is designed in particular as a fastening mechanism. Preferably, the assistance apparatus 3 can be fastened to the tool apparatus 2 and/or removed from the tool apparatus 2 by means of the fastening unit 27 in a non-destructive and/or tool-free manner. Expediently, the assistance apparatus 3 is fixed in all spatial directions relative to the tool apparatus 2 by means of the fastening unit 27 when fastened to the tool apparatus 2. Exemplarily, the fastening unit 27 comprises a clamping ring 28 and optionally a locking element 29, with which the clamping ring 28 can be clamped and/or locked. The locking element 29 is exemplarily designed as a screw. The clamping ring 28 is in particular a clamping collar.

Alternatively or additionally, the fastening unit 27 may comprise a thread or a magnet to fasten the assistance apparatus 3 to the tool apparatus 2. Furthermore, the fastening unit 27 can be designed to provide the fastening of the assistance apparatus 3 to the tool apparatus 2 by means of a clamp connection.

Expediently, the assistance apparatus 3 comprises an assistance apparatus housing 24. Exemplarily, the assistance apparatus housing 24 provides the assistance apparatus handle section 25. Expediently, the electrical assistance device 30 is at least partially disposed in or on the assistance apparatus housing 24. Exemplarily, an assistance apparatus energy storage 31, the assistance apparatus communication unit 32, an assistance apparatus sensor unit 35, an assistance apparatus control unit 36, and/or a non-volatile memory 37 of the assistance device 30 are arranged inside the assistance apparatus housing 24. Further, exemplarily, a user interface 33 and/or an assistance apparatus actuator unit 34 are arranged externally on the assistance apparatus housing 24, exemplarily on the assistance apparatus handle section 25 and/or the fastening section 26.

The electrical assistance device 30 will be discussed in more detail below.

Exemplarily, the electrical assistance device 30 comprises (in addition to the assistance apparatus communication unit 32) the assistance apparatus energy storage unit 31, the user interface 33, the assistance apparatus actuator unit 34, the assistance apparatus sensor unit 35, the assistance apparatus control unit 36, and/or the non-volatile memory 37.

According to a possible embodiment of the assistance apparatus, the assistance apparatus communication unit 32 is optional. According to this possible embodiment, the assistance apparatus communication unit 32 may not be present.

Exemplarily, the assistance apparatus control unit 36 comprises a microcontroller. The assistance apparatus control unit 36 is preferably present in addition to and/or independently of a tool apparatus control unit 7 of the tool apparatus 2. According to a possible embodiment, the assistance apparatus control unit 36 is adapted to perform machine learning, in particular to provide the assistance function using the machine learning.

Expediently, the tool apparatus control unit 7 is in communicative connection with the assistance apparatus communication unit 32, the user interface 33, the assistance apparatus actuator unit 34, the assistance apparatus sensor unit 35, and/or the non-volatile memory 37. Preferably, the tool apparatus control unit 7 is powered by the assistance apparatus energy storage unit 31.

The assistance apparatus energy storage 31 serves to supply energy to the entire assistance device 30, preferably to the entire assistance apparatus 3. In particular, the assistance apparatus energy storage 31 represents a separate energy supply for the assistance apparatus 3. Expediently, the assistance apparatus 3 does not require any further energy source in addition to the assistance apparatus energy storage 31 in order to be operated.

In particular, the assistance apparatus energy storage 31 is implemented as a rechargeable energy storage, expediently as an accumulator. For example, the assistance apparatus energy storage 31 comprises a battery.

According to a possible embodiment, the assistance apparatus 3 is configured to charge the assistance apparatus energy storage 31 with electrical energy from the tool apparatus 2. Preferably, the assistance apparatus 3 comprises an energy storage charging port (not shown in the figures) for connecting the assistance apparatus 3 to an electrical energy source, for example the tool apparatus 2, to charge the assistance apparatus energy storage 31.

The assistance apparatus energy storage 31 is expediently not used to supply the tool apparatus 2 with energy and is in particular provided in addition to an energy storage 21 of the tool apparatus 2.

The assistance apparatus 3 has its own energy supply in the form of the assistance apparatus energy storage 31. In an exemplary case, the assistance apparatus energy storage 31 is permanently installed in the assistance apparatus 3, in particular within the assistance apparatus housing 24. The assistance apparatus energy storage 31 is expediently not removable from the assistance apparatus 3 and/or not replaceable.

According to one possible embodiment, the assistance apparatus 3 is designed to generate electrical energy to charge the assistance apparatus energy storage 31 and/or to supply the assistance device 30 with energy. For example, the assistance apparatus 3 is configured to generate the electrical energy using energy harvesting. Further, the assistance apparatus 3 may comprise a solar cell array to generate the electrical energy. Further, the assistance apparatus 3 may be configured to generate the electrical energy by means of power take-off, PTO, of a drive unit 6 of the tool apparatus 2.

Expediently, the assistance apparatus 3 is further configured to receive electrical energy wirelessly, for example via induction, and to use the received electrical energy to charge the assistance apparatus energy storage 31 and/or to supply the assistance device 30.

The assistance apparatus communication unit 32 is used in particular for data transmission between the assistance apparatus 3 and the tool apparatus 2. Preferably, the data transmission takes place as part of the provision of the assistant function.

For example, the assistance device 30 is configured to transmit control information for controlling the machining operation to the tool apparatus 2 via the assistance apparatus communication unit 32. The control information is expediently generated by the assistance apparatus control unit 36, for example on the basis of sensor information detected by the assistance apparatus sensor unit 35. The control information is expediently used to influence the drive of the tool 4, for example to stop it.

Furthermore, the assistance device 30 is expediently configured to receive configuration information for configuring the assistance function via the assistance apparatus communication unit 32. The configuration information relates, for example, to specific properties of the tool apparatus 2, in particular the tool 4. By means of the transmission of configuration information, the assistance function can be adapted to the tool apparatus 2, in particular the tool 4.

In particular, the assistance apparatus communication unit 32 is designed to communicate wirelessly with the tool apparatus 2. For example, the assistance apparatus communication unit 32 comprises an RFID unit, a Bluetooth unit, a WLAN unit and/or an NFC unit for communication with the tool apparatus 2.

Furthermore, the assistance apparatus communication unit 32 may also be configured to communicate with the tool apparatus 2 by wire. For example, the assistance apparatus communication unit 32 comprises one or more sliding contacts for communication with the tool apparatus 2.

The user interface 33 is preferably a human machine interface. The user interface 33 is used in particular for the input (by a user) of a target specification, in particular with regard to the machining operation to be performed with the tool apparatus 2 and/or the assistance function supporting the machining operation.

The user interface 33 expediently comprises one or more control elements, which are used in particular for inputting and/or manipulating the target specification. For example, a button and/or a touch screen is provided as a control element.

Exemplarily, the user interface 33 serves to perform a zero point calibration by means of a user input. For example, the assistance apparatus 3 is designed to detect the current distance from the assistance apparatus 3 to a workpiece to be machined and/or a wall to be machined as a zero point in response to the user input.

Further, the user interface 33 expediently serves to display assistance data. The assistance data comprises, for example, specification data relating to the machining operation and/or the assistance function, and/or status data relating to the assistance apparatus 3, the tool apparatus 2 and/or a workpiece machined with the tool apparatus 2. The user interface 33 expediently comprises a visual display, in particular a display. Furthermore, the user interface 33 may be configured to provide an acoustic signal to the user.

The assistance apparatus actuator unit 34 comprises, for example, a light source, in particular an LED. Expediently, the assistance apparatus actuator unit 34 is designed to illuminate a work area. Furthermore, the assistance apparatus actuator unit 34 is preferably configured to provide a projection, for example onto a workpiece. The projection comprises, for example, a marking and/or additional information relating, for example, to a battery status, a work progress and/or status data, in particular machine data.

The assistance apparatus sensor unit 35 is expediently designed to detect a physical variable relating to the machining operation, the workpiece to be machined and/or the tool apparatus 2 and expediently to provide it as sensor information. For example, the assistance apparatus sensor unit 35 comprises a distance sensor and/or an inertial sensor, for example an acceleration sensor and/or a rotation rate sensor.

The non-volatile memory 37 serves in particular as an information memory. Preferably, key figures, in particular safety-relevant key figures, are stored in the non-volatile memory 37.

In the following, the tool apparatus 2 will be discussed in more detail:

The tool apparatus 2 is in particular a hand-held power tool. Exemplarily, the tool apparatus 2 comprises a tool 4, for example a drill, and is designed to perform the machining operation with the tool 4, in particular to machine the workpiece, for example to drill. The tool apparatus 2 comprises a drive unit 6 for driving, in particular rotationally driving, the tool 4. The drive unit 6 expediently comprises a motor, in particular an electric motor, and/or a gearbox. Exemplarily, the tool apparatus 2 comprises a drive shaft 5 for rotational coupling of the tool 4 to the drive unit 6.

The tool apparatus 2 does not include the assistance apparatus 3 and, in particular, is a separate device from the assistance apparatus 3.

The tool apparatus 2 comprises a tool apparatus body 11 to which, exemplarily, the tool 4 is attached. The tool apparatus body 11 comprises a tool apparatus collar 8 and a base section 12. The tool apparatus collar 8 extends coaxially with respect to the drive shaft 5. Exemplarily, the tool apparatus collar 8 adjoins the base section 12 in the axial direction of the drive shaft 5. Exemplarily, the tool apparatus collar 8 comprises a first axial collar section 9, which is preferably stationary, i.e. in particular does not rotate with the drive shaft 5. Exemplarily, the first axial collar section 9 adjoins the base section 12 in the axial direction of the drive shaft 5. Expediently, the tool apparatus collar 8 further comprises a second axial collar section 10, which is preferably non-stationary, i.e. in particular co-rotates with the drive shaft 5. Exemplarily, the second axial collar section 10 joins the first axial collar section 9 in the axial direction of the drive shaft 5. The second axial collar section 10 expediently comprises a tool fastening device, for example a drill chuck, for fastening the tool 4.

Exemplarily, the base section 12 comprises a drive section 14, a handle section 15 and/or an energy storage section 16. The drive section 14 comprises the drive unit 6. In particular, the handle section 15 is designed as a handle and adjoins the drive section 14 (in particular at the bottom).

The section formed by the tool apparatus collar 8, the drive section 14 and the handle section 15 shall also be referred to as the working section 18. The working section 18 is expediently the tool apparatus 2, in particular the tool apparatus body 11, without the energy storage section 16.

The energy storage section 16 adjoins (in particular at the bottom) the handle section 15. The energy storage section 16 expediently comprises an energy storage 21, in particular a rechargeable energy storage unit, for example an accumulator. The energy storage 21 serves as energy supply, in particular as the sole energy supply, to the tool apparatus 2, in particular the drive unit 6 and/or the tool apparatus control unit 7. The energy storage 21 preferably does not serve to supply energy to the assistance apparatus 3.

The tool apparatus 2 expediently comprises an energy storage attachment interface 22. The energy storage attachment interface 22 is preferably arranged at the bottom of the handle section 15. The energy storage attachment interface 22 expediently serves for releasably attaching the energy storage section 16 to the handle section 15. Expediently, the energy storage section 16 can be attached and/or released from the handle section 15 by means of the energy storage attachment interface 22 in a tool-free and/or non-destructive manner. Preferably, the attachment and/or detachment of the energy storage section 16 is performed by a sliding movement relative to the handle section 15.

The energy storage section 16 may also be referred to as a battery module. Expediently, the energy storage section 16 is a replaceable battery module.

The tool apparatus 2 comprises an actuating device 23, for example a button, in particular a trigger, which is expediently arranged on the handle section 15 and serves in particular to effect a drive of the tool 4 by the drive unit 6.

The tool apparatus 2 further expediently comprises a tool apparatus control unit 7 and/or a tool apparatus communication unit 20. The tool apparatus control unit 7 is preferably in communicative connection with the actuating device 23, the drive unit 6 and/or the tool apparatus communication unit 20. The tool apparatus control unit 7 is preferably arranged in the drive section 14 and/or in the handle section 15 and preferably comprises a microcontroller. In particular, the tool apparatus control unit 7 is arranged in the working section 18. The tool apparatus communication unit 20 is preferably arranged in the energy storage section 16.

The tool apparatus control unit 7 expediently comprises a working section communication unit 38 for communication with the tool apparatus communication unit 20, in particular by wire. The tool apparatus control unit 7 expediently further comprises a tool apparatus memory 39, in particular a non-volatile memory, and a tool apparatus processing unit 40.

The tool apparatus 2 comprises a housing 17, which expediently provides the outer walls of the drive section 14, handle section 15 and/or the energy storage section 16. Expediently, the drive unit 6, the tool apparatus control unit 7 and/or the tool apparatus communication unit 20 are arranged in the housing 17. On the housing 17, exemplarily, the actuating device 23 is arranged. The housing 17 expediently includes an energy storage housing section 19 belonging to the energy storage section 16, which energy storage housing section 19 is detachable from the remaining part of the housing 17 when the energy storage section 16 is detached. This remaining part of the housing 17—that is, in particular, the housing 17 without the energy storage housing section 19—may also be referred to as the working section housing section.

The tool apparatus 2 is expediently operable without the assistance apparatus 3. Preferably, the tool 4 can be driven without the assistance apparatus 3 (for example, by means of the drive unit 6). In particular, the assistance apparatus 3 is not required in order to effect a drive of the tool 4 and/or to perform the machining operation with the tool apparatus 2. For example, as a machining operation a drilling operation can be carried out with a tool apparatus 2 designed as a drilling machine, without the assistance apparatus 3 being required for this.

The assistance apparatus 3 serves to support the machining operation—in particular, it is intended to facilitate and/or improve the machining operation.

In the following, the interaction between the assistance apparatus 3 and the tool apparatus 2 shall be discussed in more detail.

The assistance apparatus 3 is designed in particular as an auxiliary-handle module for the tool apparatus 2. The tool apparatus 2 comprises the handle section 15, which expediently represents a handle with which the tool apparatus 2 can be gripped, carried and/or hand-guided during the machining operation. The assistance apparatus 3, which is configured as an auxiliary-handle module, provides (in a state attached to the tool apparatus 2) an auxiliary handle that is additional to the handle provided by the handle section 15. For example, the handle provided by the handle section 15 is for being gripped by a first hand of the user during the machining operation, and the auxiliary handle provided by the assistance apparatus 3 is for being gripped by a second hand of the user during the machining operation.

Expediently, the assistance apparatus 3 can be detachably fastened with the fastening unit 27—for example the clamping ring 28—to the tool apparatus 2, in particular to the tool apparatus collar 8, preferably to the first axial collar section 9. According to a first configuration (not shown in the figure), the assistance apparatus 3 is fastened with the fastening unit 27—for example the clamping ring 28—to the tool apparatus 2, in particular to the tool apparatus collar 8, preferably to the first axial collar section 9.

In particular, the assistance apparatus 3 is not attachable between the energy storage section 16 and the working section 18, in particular the handle section 15. In a state in which the assistance apparatus 3 is attached to the tool apparatus 2 by the fastening unit 27, the assistance apparatus 3 is in particular not located between the energy storage section 16 and the working section 18, in particular the handle section 15. The assistance apparatus 3 is in particular not attachable to the energy storage attachment interface 22, and expediently in the state in which the assistance apparatus 3 is attached to the tool apparatus 2, the assistance apparatus 3 is not attached to the energy storage attachment interface 22.

In the first configuration—i.e. when the assistance apparatus 3 is attached to the tool apparatus 2 by the fastening unit 27 and together with the tool apparatus 2 forms the tool device 1—the assistance apparatus 3 is expediently located in an upper region, in particular in the upper half, of the tool device 1. Expediently, the assistance apparatus 3 is located in the region of the drive shaft 5, in the region of an output shaft (not shown) and/or in the region of the tool 4. For example, the assistance apparatus 3, in particular the fastening unit 27, surrounds the drive shaft 5 and/or an imaginary axis defined by the drive shaft 5. Preferably, the assistance apparatus 3 is located closer to the drive shaft 5, the output shaft and/or the tool than to the drive unit 6. Exemplarily, the assistance apparatus 3 is located on the side of the handle section 15 facing away from the energy storage section 16. Preferably, the assistance apparatus 3 is located in a front area of the tool device 1. Expediently, the assistance apparatus 3 is located in an area between the tool 4 and the drive unit 6.

The fastening of the assistance apparatus 3 to the tool apparatus 2 is expediently based on a frictional connection. The fastening is expediently releasable—in particular tool-free and/or non-destructive. For example, the frictional connection can be released by actuating the locking element 29, for example by turning the locking element 29, so that the assistance apparatus 3 can be removed from the tool apparatus.

Expediently, there is no electrical contact, in particular no wired connection, between the assistance apparatus 3 and the tool apparatus 2, in particular in the state in which the assistance apparatus 3 is fastened to the tool apparatus 2 ready for operation.

Expediently, the communication between the assistance apparatus 3 and the tool apparatus 2 is wireless, in particular exclusively wireless.

Exemplarily, the wireless communication between the assistance apparatus 3 and the tool apparatus 2 takes place via the energy storage section 16—i.e. in particular via the battery module of the tool apparatus 2. In a preferred embodiment, the communication between the assistance apparatus 3 and the tool apparatus 2 takes place via Bluetooth.

Thus, the tool apparatus 2 comprises the detachable energy storage section 16 with the energy storage 21 for supplying energy to the tool apparatus 2. The energy storage section 16 comprises the tool apparatus communication unit 20 for communicating with the assistance apparatus communication unit 32. Preferably, the tool apparatus communication unit 20 for communicating with the assistance apparatus 3 comprises an RFID unit, a Bluetooth unit, a WLAN unit, and/or an NFC unit, which is or are expediently arranged in the energy storage section 16.

Expediently, the energy storage section 16, in particular the battery module of the tool apparatus 2, provides a gateway for communication between the assistance apparatus 3 and the tool apparatus 2.

The gateway function of the energy storage section 16 is shown in particular in FIG. 4. The assistance apparatus communication signals 50 sent by the assistance apparatus communication unit 32 to the tool apparatus 2 are transmitted wirelessly to the tool apparatus communication unit 20 (located in the energy storage section 16). The tool apparatus communication unit 20 then transmits the assistance apparatus communication signals 50 as a tool apparatus input signal 61, in particular by wire, to the working section 18 of the tool apparatus 2, in particular the tool apparatus control unit 7 (arranged in the working section 18), expediently a working section communication unit 38 of the tool apparatus control unit 7. The tool apparatus communication signals 60 to be transmitted from the tool apparatus 2 to the assistance apparatus 3 are first transmitted as tool apparatus output signals 61 by wire from the working section 18, in particular the tool apparatus control unit 7, preferably the working section communication unit 38 to the tool apparatus communication unit 20, and then from the tool apparatus communication unit 20 wirelessly to the assistance apparatus 3.

For example, the assistance apparatus communication signals include the identification information (for identifying the user), the assistance apparatus identification information, the assistance apparatus user input information, the assistance apparatus sensor information, and/or the control information.

For example, the tool apparatus communication signals include the tool apparatus identification information, the tool apparatus status information, the tool apparatus sensor information, the tool apparatus user input information, and/or the configuration information.

Conveniently, there is no direct communication (bypassing the energy storage section 16) between the assistance apparatus 3 and the working section 18, in particular the tool apparatus control unit 7; i.e., all communication between the assistance apparatus 3 and the tool apparatus control unit 7 takes place via the energy storage section 16—i.e., in particular the battery module—of the tool apparatus 2. The energy storage section 16, as a gateway, in particular performs a conversion from wireless to wired communication signals.

Expediently, the tool apparatus 2 does not comprise any other wireless communication unit, in particular no radio element, apart from the tool apparatus communication unit 20 arranged in the energy storage section 16. In particular, no wireless communication unit, especially no radio element, is present in the working section 18.

Expediently, feedback to the tool apparatus 2 is provided via the communication between the assistance apparatus 3 and the tool apparatus 2. According to a possible embodiment, a control loop is provided in which sensor information detected by the assistance apparatus 3, for example the assistance apparatus sensor unit 35, is transmitted to the tool apparatus 2 as a feedback variable and the tool apparatus 2 provides a manipulated variable, for example for driving the tool 4, on the basis of the feedback variable.

According to a further embodiment, via the communication between the assistance apparatus 3 and the tool apparatus 2 a control of the tool apparatus 2 by the assistance apparatus 3 is provided. For example, the assistance apparatus 3 can influence, for example stop, the drive of the tool 4 by transmitting the control information.

Exemplarily, the assistance apparatus control unit 36 is configured to generate the control information, in particular based on user input information and/or state information, for example sensor information. Exemplarily, the assistance apparatus 3 is designed to receive the user input information and/or the status information from the tool apparatus 2.

The user input information is in particular a tool apparatus user input information—i.e. information entered by the user at the tool apparatus 2, for example by actuating the actuating device 23. The state information is in particular a tool apparatus state information—i.e. state information generated by the tool apparatus 2. The sensor information is in particular a tool apparatus sensor information—i.e. a tool information generated by the tool apparatus 2.

According to a preferred embodiment, the assistance apparatus 3 and the tool apparatus 2 form a control loop, with the assistance apparatus 3 expediently specifying the driving of the tool 4 to the tool apparatus 2. The assistance apparatus 3 acts expediently in relation to the tool apparatus 2 as a superordinate control. Thus, the assistance apparatus 3 is in particular above the tool apparatus 2 in the control hierarchy. In particular, the assistance apparatus 3 provides the controller—i.e. the “brain” or intelligence, so to speak—in the control loop. Expediently, the assistance apparatus 3 exerts the control of the tool apparatus 2 by providing the control information.

For example, the assistance apparatus 3 receives the user input information and/or the state information, in particular the sensor information, from the tool apparatus 2, and generates the control information based on this received information. For example, the assistance apparatus 3 comprises an artificial intelligence (AI) component, for example a neural network, and is adapted to generate the control information using the AI component. The assistance apparatus 3 is configured to transmit the control information to the tool apparatus 2. The tool apparatus 2 is configured to perform the machining operation, in particular the control of the tool 4, according to the control information. Preferably, the tool apparatus 2 is designed to control the drive unit 6 with the control information.

The control information comprises in particular one or more control commands. The control information preferably specifies a control of the tool 4, for example by means of the drive unit 6. For example, the control information specifies a movement to be performed by the tool 4 and/or a force to be provided with the tool 4 and/or a torque to be provided with the tool 4. Exemplarily, the control information specifies a direction of rotation and/or a rotational speed of the tool 4.

The assistance apparatus 3 expediently supports the machining operation and sends the control information to the tool apparatus 2 for this purpose. The machining operation performed by the tool apparatus 2 is actively influenced via the control information. The tool apparatus 2 sends status information, for example sensor information, which results for example from the influenced machining operation, to the assistance apparatus 3. The assistance apparatus 3 processes the status information and generates, on the basis of the status information, further control information for transmission to the tool apparatus 2 and for influencing the machining operation.

The state information preferably comprises one or more operating parameters of the tool apparatus 2—for example, the degree of actuation of the actuation device 23 (for example, a throttle lever), a current torque of the tool 4, and/or a current current consumption of the drive unit 6.

According to a preferred embodiment, the assistance apparatus 3 is designed to convert coarse dosing information of a movement, force and/or torque for the tool 4, which is input by the user by means of the actuating device 23, into fine dosing information and to effect control of the tool 4 according to the fine dosing information. The fine dosing information preferably has a higher resolution than the coarse dosing information, i.e. in particular a finer gradation. For example, the coarse dosing information has a resolution of 1 bit—i.e. 0 or 1—and the fine dosing information has a higher resolution than 1 bit.

The fine dosing information comprises, for example, a movement course, force course and/or torque course for the machining operation. For example, the fine dosing information specifies a changing movement of the tool 4, in particular a movement in which the tool 4 first moves in a first direction and then in a second direction different from the first direction. The fine dosing information is transmitted, for example, as the control information from the assistance apparatus 3 to the tool apparatus 2. The coarse dosing information is transmitted, for example, as the tool apparatus user input information from the tool apparatus 2 to the assistance apparatus 3.

The assistance apparatus 3 expediently takes over the fine dosing of the control of the tool 4. For example, without the assistance apparatus 3, the user must take over the fine dosing, namely by means of corresponding fine-dosed actuation of the actuation device 23, in order to achieve a certain movement course, force course and/or torque course of the tool 4. For example, without the assistance apparatus 3, the user must dose the movement, force, and/or torque directly by how strongly the user actuates the actuation device 23. Furthermore, without the assistance apparatus 3, the user must vary the actuation of the actuation device 23, in particular over time—for example, press with different strengths—in order to achieve the specific movement course, force course and/or torque course of the tool 4. If the assistance apparatus 3 is present, the assistance apparatus 3 takes over the fine dosing for the user. The user now no longer has to actuate the actuation device 23 to varying degrees in order to achieve fine dosing of the movement, force and/or torque of the tool 4. The user simply needs to perform an actuation (of any strength) of the actuation device 23—for example, a coarse dosing—to initiate the fine dosing by the assistance apparatus 3. The assistance apparatus 3 then automatically provides the movement course, force course and/or torque course for the control of the tool 4, expediently as long as the user keeps the actuating device 23 pressed.

For example, the tool apparatus 2 is a thread cutter and the fine dosing information provided by the assistance apparatus 3 alternately includes a forward gear or forward movement to be performed by the tool 4 and a reverse gear or reverse movement.

Expediently, the tool apparatus is selectively operable in a manual mode or an automatic mode. In the manual mode, a value of an operating parameter for the control of the tool 4—for example a value for a movement, a force and/or a torque—is expediently entered directly via the strength of the actuation of the actuating device 23. In automatic mode, expediently, the value of the operating parameter is generated by the assistance apparatus 3 and transmitted to the tool apparatus 2 (for example as the fine dosing information), in particular in response to an actuation of the actuation device 23, in particular independently of the strength of the actuation.

For example, the manual mode is the basic mode explained below and/or the automatic mode is the extended mode explained below.

Various exemplary embodiments of the assistance apparatus 3 are to be explained below. The assistance apparatus 3 is expediently designed according to one or more of these embodiments.

According to an exemplary embodiment, the assistance apparatus 3 serves to monitor the actual drilling depth drilled with the tool apparatus 2 and, expediently, to cause the drive of the tool 4 to stop when a predetermined target drilling depth is reached. The assistance function here is thus a drilling depth monitoring and a drilling depth-dependent stopping of the tool 4.

In particular, the assistance device 30 is configured to detect an actual drilling depth with the assistance apparatus sensor unit 35 and to provide the assistance function based on the detected actual drilling depth. For example, the assistance apparatus sensor unit 35 includes a distance sensor for detecting a distance, expediently a distance, between the assistance apparatus 3 (attached to the tool apparatus 2) and the workpiece being drilled by the tool 4. The assistance apparatus control unit 36 is suitably configured to calculate an actual drilling depth based on the detected distance. The calculation is performed, for example, on the basis of configuration information describing specific properties, for example dimensions, of the tool 4 and/or of the tool apparatus 2, which information has expediently been received from the tool apparatus 2 by means of the assistance apparatus communication unit 32.

Expediently, the assistance apparatus control unit 36 is further configured to determine whether the actual drilling depth has reached the target drilling depth, for example based on a comparison of the actual drilling depth with the target drilling depth.

The assistance device 30 is expediently designed to provide control information on the basis of the detected actual drilling depth. By means of the control information, the tool apparatus 2 can expediently be informed that the target drilling depth has been reached and/or that the drive of the tool 4 is to be stopped. The control information is transmitted to the tool apparatus 2, in particular the tool apparatus control unit 7, by means of the assistance apparatus communication unit 32, in particular via the tool apparatus communication unit 20.

The tool apparatus control unit 7 receives the control information and, based on the control information, performs a control of the drive unit 6, by which the drive of the tool 4 is stopped.

The control information is therefore used to cause the tool apparatus 2 to end the machining operation. The control information is, for example, a stop signal.

The target drilling depth and/or the actual drilling depth are expediently indicated by means of the user interface 33, for example by means of the display. Furthermore, the user interface 33 expediently indicates when the actual drilling depth has reached the target drilling depth.

The target drilling depth can preferably be entered in the assistance apparatus 3, in particular by means of the user interface 33.

In the following, a further embodiment of the assistance apparatus 3 will be described. In the further embodiment, the assistance apparatus 3 serves to monitor a machining angle and to assist the user in maintaining a certain machining angle. Thus, the assistance function here is machining angle monitoring.

In particular, the machining angle is the angle between the tool 4 and a workpiece to be machined with the tool 4.

The assistance device 30 is expediently configured to detect an actual machining angle of the tool apparatus 2 by means of the assistance apparatus sensor unit 35, and to provide the assistance function based on the detected actual machining angle.

Expediently, the assistance device 30, in particular the assistance apparatus control unit 36, performs a comparison between the actual machining angle and a target machining angle, and preferably outputs feedback information based on the comparison, for example via the user interface 33 and/or the assistance apparatus actuator unit 34. The feedback information expediently indicates to the user how to align the tool apparatus 2 in order to achieve the target machining angle.

The assistance device 30 is expediently configured to receive the target machining angle via the assistance apparatus communication unit 32 and/or via the assistance apparatus user interface 33.

Expediently, the user can enter the target machining angle, for example at the tool apparatus 2, the assistance apparatus 3 and/or via an IoT (“Internet of Things”) connection to the assistance apparatus 3 and/or the tool apparatus 2.

When drilling with the tool apparatus 2 (e.g. with a Forstner drill as tool 4), a target machining angle is to be achieved by manual positioning of the tool apparatus 2. For example, a vertical (and expediently central) bore of the workpiece is to be achieved. In particular, the bore is drilled at the end face of a (for example narrow) board. The workpiece is, for example, a tray.

With the feedback information, the assistance apparatus 3 provides feedback to the user about the current angular position—i.e. the actual machining angle—of the tool apparatus 2. Furthermore, the assistance apparatus 3 assists the user in maintaining the correct angle during the drilling process.

Optionally, the assistance apparatus 3 is designed to project a machining mark, for example a crosshair, onto the workpiece, in particular during the machining operation, for example during a drilling operation. The projection is preferably performed by means of the assistance apparatus actuator unit 34. The machining mark comprises in particular a horizontal and/or a vertical alignment line (which expediently cross each other) and preferably serves to enable alignment with other bores.

Thus, the assistance function here includes the provision of a machining mark.

Expediently, the machining mark can be configured by means of configuration information. The configuration information is expediently received via the user interface 33 and/or the assistant communication unit 32.

According to a further embodiment of the assistance apparatus 3, the assistance function comprises an identification function for identifying a user. Expediently, the assistance device 30 is configured to provide identification information based on the identification of the user and to transmit the identification information to the tool apparatus 2 by means of the assistance apparatus communication unit 32. For example, the assistance apparatus sensor unit 35 comprises a biometric identification sensor, for example a fingerprint sensor, and the assistance device 30 is configured to identify the user by means of the assistance apparatus sensor unit 35—for example on the basis of the user's fingerprint —and to provide the identification information according to the user's identification.

Exemplarily, the identification function causes a unlocking and/or a configuration of the tool apparatus 2. Expediently, the tool apparatus 2 is designed to enable an execution of the machining operation, in particular to unlock a drive of the tool 4, upon receipt of the identification information. Furthermore, the tool apparatus 2 is designed to block an execution of the machining operation, in particular to block the drive of the tool 4, if no identification information is received (or if identification information is received indicating that no authorized user could be identified).

In this case, the assistance function expediently provides an anti-theft and/or security function.

According to a further embodiment, the identification information is already stored in the assistance apparatus 3, for example in the non-volatile memory 37. In this case, no assistance apparatus sensor unit 35, in particular no biometric identification sensor, is required to provide the identification information. The assistance apparatus 3 is expediently configured to transmit the identification information to the tool apparatus 2 during a communication with the tool apparatus 2, in particular by means of the assistance apparatus communication unit 32. The tool apparatus 2 is expediently configured to check whether the assistance apparatus 3 is present, for example by the tool apparatus 2 attempting to communicate with the assistance apparatus 3 and checking whether the tool apparatus 2 receives the identification information during the communication. Provided that the identification information is received, the tool apparatus 2 enables the machining operation, in particular the drive of the tool 4. If the identification information is not received, the tool apparatus 2 blocks the machining operation, in particular the drive of the tool 4.

The assistance apparatus 3 expediently provides a key function as an assistance function—the assistance apparatus 3 serves as a key that is required to be able to operate the tool apparatus 2. The tool apparatus 2 is designed to work only with a specific assistance apparatus 3. In this way, theft protection can be achieved.

According to another possible embodiment, the assistance device 30 is designed to provide an assistance function for line detection. The assistance apparatus 3 is expediently designed as a line detector. For example, the assistance apparatus sensor unit 35 comprises a line detection sensor unit.

According to another possible embodiment, the assistance device 30 is configured to provide an assistance function for orientation and/or position detection. For example, the assistance apparatus sensor unit 35 comprises a orientation and/or position detection sensor unit.

According to another possible embodiment, the assistance device 30 is configured to provide an assistance function for generating a drilling image, in particular based on the orientation and/or position detection.

According to another possible embodiment, the assistance device 30 is designed to provide a tool recognition and/or accessory recognition as an assistance function. For example, the assistance device 30 is designed to recognize a drill diameter and/or a bit insert and/or a handle and/or a drill chuck.

According to a possible embodiment, the tool apparatus 2 is designed to recognize the assistance apparatus 3, in particular the assistance function of the assistance apparatus 3. For example, the tool apparatus 2 is designed to recognize the assistance apparatus 3 and/or the assistant function via communication with the assistance apparatus 3, in particular via the assistance apparatus communication unit 32.

According to another possible embodiment, the assistance device 30 is configured to provide an assistance function for distance detection, in particular with respect to a depth and/or a plane. For example, the assistance apparatus sensor unit 35 comprises a distance detection sensor unit. Expediently, the assistance device 30 is designed to ensure a depth-limited screwing-in, in particular by providing the tool apparatus 2 with corresponding control information in order to terminate the screwing-in when a certain screwing depth is reached.

According to another possible embodiment, the assistance device 30 is configured to provide an assistance function for condition measurement. For example, the assistance apparatus sensor unit 35 comprises a temperature sensor. Furthermore, the assistance device 30 may be configured to provide an assistance function for detecting the tool condition.

According to another possible embodiment, the assistance apparatus 3 comprises a flexible shaft with light to expediently enable drilling around the corner. The assistance apparatus suitably combines an angular gear and a flexible extension.

According to another possible embodiment, the assistance apparatus comprises a riveting attachment and is used in particular for forceless riveting.

According to another possible embodiment, the assistance apparatus 3 is designed for torque detection. Expediently, a sensor is arranged directly on the output, for example on the drive unit 6, in order to detect the torque.

According to another possible embodiment, the assistance apparatus 3 comprises a compressed air blower, for example a leaf blower.

According to another possible embodiment, the assistance apparatus 3 comprises a thread cutter and is designed to react automatically to a tilting of the thread cutter, for example by transmitting a corresponding control information to the tool apparatus 2 (which serves, for example, to drive the thread cutter).

According to another possible embodiment, the assistance apparatus 3 comprises a cartridge press.

According to a further possible embodiment, the assistance apparatus 3 comprises a suction aid and/or a drilling aid and is designed in particular for autonomous suction and/or aspiration during drilling.

According to another possible embodiment, the assistance apparatus 3 comprises a nailer and/or a tracker attachment.

According to another possible embodiment, the assistance apparatus 3 comprises a folding device and is used in particular to bend steel.

According to another possible embodiment, the assistance apparatus 3 comprises a bolt shear and/or a plate shear.

According to another possible embodiment, the assistance apparatus 3 comprises a ratcheting system, in particular for screws and bit protection (ABS).

According to another possible embodiment, the assistance apparatus 3 is designed to detect when exposure values are reached and/or to issue a warning when the exposure values are reached.

According to another possible embodiment, the assistance apparatus comprises a barcode scanner and/or is designed as an Internet of Things (IoT) device.

Various configurations of the tool device 1 will be explained below.

According to a first configuration (for example, the first configuration explained above), the tool device 1 comprises the tool apparatus 2 and an assistance apparatus 3, in particular exactly one assistance apparatus 3. The assistance apparatus 3 is attached to the tool apparatus 2.

The tool device 1 can be put from the first configuration into a second configuration in which the assistance apparatus 3 is completely detached from the tool apparatus 2 (as shown in FIG. 1).

According to a third configuration, the tool device 1 comprises the tool apparatus 2 and two, in particular exactly two, assistance apparatuses 3—namely a first assistance apparatus and a second assistance apparatus. Each assistance apparatus is expediently designed according to one of the embodiments explained above. Preferably, the first and/or the second assistance apparatus is designed as a handle module. Expediently, the two assistance apparatuses differ from each other—in particular in their assistance function. For example, the first assistance apparatus is implemented according to a first of the embodiments explained above and the second assistance apparatus is implemented according to a second of the embodiments explained above. Expediently, the two assistance apparatuses cannot be attached to the tool apparatus 2 at the same time, since the tool apparatus 2 provides space for only one assistance apparatus, for example. In particular, the second assistance apparatus can be attached to the tool apparatus 2 as an alternative to the first assistance apparatus. In the third configuration, the first assistance apparatus is attached to the tool apparatus 2 and the second assistance apparatus is detached from the tool apparatus 2.

The tool device can be put from the third configuration into a fourth configuration, in which the first assistance apparatus is replaced by the second assistance apparatus. In the fourth configuration, the first assistance apparatus is detached from the tool apparatus 2 and (instead of the first assistance apparatus) the second assistance apparatus is attached to the tool apparatus 2.

The tool device can further be moved from the fourth configuration to a fifth configuration in which both assistance apparatuses are detached from the tool apparatus.

Expediently, the tool apparatus is ready for operation in the fifth configuration—i.e., it can in particular carry out the machining operation without the two assistance apparatuses, in particular, it can drive the tool 4 by means of the drive unit 6. The two assistance apparatuses serve expediently only for the support of the machining operation and are not necessary for the machining operation itself.

With reference to FIG. 2, a method for operating the tool device 1 will be discussed below.

The method starts with step S1, in which a first assistance apparatus 3 is attached to the tool apparatus 2. The method continues with step S2, in which a machining operation is performed with the tool apparatus 2 under the support of the assistance function of the first assistance apparatus 3.

Expediently, the method continues with step S3, in which the first assistance apparatus 3 is removed from the tool apparatus 2. The method continues with the optional step S4, in which a machining operation is performed with the tool apparatus 2 without the assistance apparatus 3.

Expediently, the method proceeds to step S5, in which a second assistance apparatus is attached to the tool apparatus 2. Preferably, the assistance function provided by the second assistance apparatus is different from the assistance function provided by the first assistance apparatus. The method proceeds to step S6, in which a machining operation is performed with the tool apparatus 2 assisted by the assistance function of the second assistance apparatus 3.

With reference to FIG. 3, a further method of operating the tool device 1 will be described below.

The method starts with step P1, in which the assistance apparatus 3 is switched on. Expediently, the assistance apparatus 3 is switched on via an actuation of the user interface 33. Furthermore, the assistance apparatus 3 can be expediently designed to switch on automatically when attached to the tool apparatus 2.

The method continues with step P2, in which the tool device 1 performs an identification procedure. Expediently, the assistance apparatus 3 is designed to automatically start the identification procedure after being switched on.

In the identification procedure, for example, the tool apparatus 2 transmits tool apparatus identification information to the assistance apparatus 3 and/or the assistance apparatus 3 transmits assistance apparatus identification information to the tool apparatus 2. The tool apparatus identification information comprises, for example, a tool apparatus identifier including, for example, the type of the tool apparatus. The assistance apparatus identification information comprises, for example, an assistance apparatus identifier including, for example, the type of the assistance apparatus.

The method continues with step P3, in which the assistance apparatus 3 and/or the tool apparatus 2 adopt one of a plurality of possible operating modes, expediently based on the identification procedure, in particular based on the received tool apparatus identification information and/or the received assistance apparatus identification information.

For example, the assistance apparatus 3 and/or the tool apparatus 2 each include a basic mode and an extended mode, and each adopt one of these two modes based on the identification procedure.

For example, the assistance apparatus 3 is designed to provide the assistance function in the basic mode to support the machining operation without communicating with the tool apparatus 2 during the machining operation. In particular, the assistance apparatus 3 can be designed to provide the assistance function in the basic mode to support the machining operation without transmitting the control information for controlling the machining operation to the tool apparatus 2.

For example, the assistance apparatus 3 is designed to communicate with the tool apparatus 2 in the extended mode during the provision of the assistance function to support the machining operation. In particular, the assistance apparatus 3 can be designed to transmit the control information for controlling the machining operation to the tool apparatus 2 in the extended mode during the provision of the assistance function for supporting the machining operation.

Furthermore, for example, the tool apparatus 2 is configured not to communicate with the tool apparatus 2 in the basic mode during the execution of the machining operation. In particular, the tool apparatus 2 can be designed to perform the machining operation in the basic mode without receiving the control information for controlling the machining operation from the assistance apparatus 3.

For example, the tool apparatus 2 is configured to communicate with the tool apparatus 2 in the extended mode while performing the machining operation. In particular, the tool apparatus 2 can be configured to receive the control information for controlling the machining operation from the assistance apparatus 3 in the extended mode during the execution of the machining operation.

Exemplarily, in the extended mode, step P4 is performed in which the assistance apparatus 3 provides a communication link to the tool apparatus 2 to provide the assistance function using this communication link.

For example, when the identification procedure is successful (for example, when extended compatibility between the assistance apparatus 3 and the tool apparatus 2 is determined), a wireless communication link is established between the assistance apparatus 3 and the tool apparatus 2.

If the identification procedure is unsuccessful (for example, if extended compatibility between the assistance apparatus 3 and the tool apparatus 2 has not been established), no wireless communication link is established between the assistance apparatus 3 and the tool apparatus 2.

In the basic mode, step P4 is skipped as an example and the procedure continues with step P5.

In step P5, the assistance apparatus 3 provides the assistance function, in particular while the tool apparatus 2 is performing the machining operation. For example, the machining operation is the drilling of a hole.

During the provision of the assistance function, step P6 and/or step P7 is executed first. Furthermore, it is also possible that neither step P6 nor step P7 is executed and the procedure continues in particular with step P9.

At step P6, the assistance apparatus 3 acquires sensor data, for example, by means of the assistance apparatus sensor unit 35 and/or based on tool apparatus sensor information transmitted from the tool apparatus 2 to the assistance apparatus 3. The sensor data originates, for example, from a distance sensor and/or a line finder of the assistance apparatus sensor unit 35. Furthermore, the sensor data originates, for example, from a current sensor and/or a magnetic sensor, in particular a Hall sensor, of the tool apparatus 2.

At step P7, the assistance apparatus 3 detects an operator input, for example, an actuation of the user interface 33 and/or an actuation of the actuation device 23, which is transmitted as tool apparatus user input information from the tool apparatus 2 to the assistance apparatus 3.

At step P8, the assistance apparatus 3 performs data processing of the sensor data and/or the operator input, in particular using the assistance apparatus control unit 36.

The method proceeds to step P9, in which the assistance apparatus 3 executes a program sequence stored in the assistance apparatus control unit 36, in particular based on the data processing performed in step P8.

According to a possible embodiment (especially if steps P6, P7 and/or P8 are not executed), the program flow sequence also be executed without additional information from external sources (for example, data from sensors and/or user inputs).

As a result of step P9, the assistance apparatus 3 expediently performs an assistance action to assist the user in the machining operation.

Exemplarily, step P10, P11 and/or P12 is performed as an assistance action.

At step P10, the assistance apparatus 3 outputs a signal, in particular a visual or an acoustic signal, to the user, in particular by means of the user interface 33. For example, the assistance apparatus 3 outputs an actual drilling depth and/or outputs that a target drilling depth has been reached.

At step P11, the assistance apparatus 3 performs data storage, in particular into the non-volatile memory 37.

At step P12, the assistance apparatus 3 transmits the control information to the tool apparatus 2.

The procedure then returns to step P5.

1. An assistance apparatus for a hand-held tool apparatus, the assistance apparatus comprising:
a fastening unit for detachably fastening the assistance apparatus to the tool apparatus, and
an electrical assistance device which is designed to provide an assistance function for supporting a machining operation of the tool apparatus, the electrical assistance device comprising an assistance apparatus communication unit for communicating with the tool apparatus.

2. The assistance apparatus according to claim 1, wherein the assistance apparatus is designed as a handle module.

3. The assistance apparatus according to claim 1, wherein the assistance apparatus communication unit is designed to communicate wirelessly with the tool apparatus.

4. The assistance apparatus according to claim 1, wherein the assistance device is designed to receive user input information, status information, and/or configuration information for configuring the assistance function from the tool apparatus via the assistance apparatus communication unit.

5. The assistance apparatus according to claim 1, wherein the assistance device is designed to transmit control information for controlling the machining operation to the tool apparatus via the assistance apparatus communication unit.

6. The assistance apparatus according to claim 5, further comprising an assistance apparatus control unit adapted to calculate the control information, based on user input information, state information, and/or configuration information.

7. The assistance apparatus according to claim 1, wherein the assistance device comprises an assistance apparatus sensor unit and is designed to detect an actual drilling depth by means of the assistance apparatus sensor unit and to provide the assistance function on the basis of the detected actual drilling depth.

8. The assistance apparatus according to claim 7, wherein the assistance device is designed to provide control information for the tool apparatus based on the detected actual drilling depth.

9. The assistance apparatus according to claim 8, wherein the control information serves to cause the tool apparatus to terminate the machining operation.

10. The assistance apparatus according to claim 1, wherein the assistance device comprises an assistance apparatus sensor unit and is designed to detect an actual machining angle of the tool apparatus by means of the assistance apparatus sensor unit and to provide the assistance function on the basis of the detected actual machining angle.

11. The assistance apparatus according to claim 10, wherein the assistance device is configured to receive a target machining angle via the assistance apparatus communication unit and/or via an assistance apparatus user interface and to provide the assistance function based on the target machining angle.

12. The assistance apparatus according to claim 1, wherein the assistance function comprises an identification function for identifying a user.

13. The assistance apparatus according to claim 12, wherein the assistance device is designed to provide identification information based on the identification of the user and to transmit the identification information to the tool apparatus by means of the assistance apparatus communication unit.

14. The assistance apparatus according to claim 1, further comprising an assistance apparatus energy storage serving as a power supply for the assistance apparatus.

15. The assistance apparatus according to claim 1, wherein the assistance apparatus is adapted to perform, using the assistance apparatus communication unit, an identification procedure with the tool apparatus and to adopt one of a plurality of possible operating modes based on the identification procedure.

16. The assistance apparatus according to claim 15, wherein the possible operating modes comprise a basic mode in which the assistance apparatus does not send control information to the tool apparatus when providing the assistance function, and an extended mode in which the assistance apparatus sends the control information to the tool apparatus when providing the assistance function.

17. A tool device comprising a first assistance apparatus according to claim 1 and the hand-held tool apparatus.

18. The tool device according to claim 17, wherein the tool apparatus comprises a detachable energy storage section having an energy storage for supplying energy to the tool apparatus, and the energy storage section comprises a tool apparatus communication unit for communicating with the assistance apparatus communication unit.

19. The tool device according to claim 17, wherein the tool device further comprises a second assistance apparatus according to claim 1, wherein the assistance function provided by the second assistance apparatus is different from the assistance function provided by the first assistance apparatus.

20. The tool device according to claim 19, wherein the second assistance apparatus is attachable to the tool apparatus as an alternative to the first assistance apparatus.

21. The tool device according to claim 17, wherein, in a state in which the first assistance apparatus is fastened to the tool apparatus with its fastening unit, the first assistance apparatus is not fastened between an energy storage section of the tool apparatus and a handle section, of the tool apparatus.

22. The tool device according to claim 17, wherein the first assistance apparatus is fastened with its fastening unit to a tool apparatus collar of the tool apparatus.

23. The tool device according to claim 17, wherein the assistance apparatus is configured to transmit control information to the tool apparatus via the assistance apparatus communication unit, and the tool apparatus is configured to control the machining operation with the control information.

24. The tool device according to claim 17, wherein the assistance apparatus is configured to convert coarse dosing information input by means of an actuating device of the tool apparatus into fine dosing information, which comprises a movement profile, a force profile and/or a torque profile, and to transmit the fine dosing information to the tool apparatus, and the tool apparatus is configured to control the tool according to the fine dosing information.

25. The tool device according to claim 17, wherein the tool apparatus is adapted to perform an identification procedure by communicating with the assistance apparatus and to adopt one of a plurality of possible operating modes based on the identification procedure.

26. A method of operating a tool device according to claim 17, comprising the steps:
fastening the first assistance apparatus to the tool apparatus,
performing a machining operation with the tool apparatus with assistance from the assistance function of the first assistance apparatus.

27. The method of claim 26, further comprising the steps of:
removing the first assistance apparatus from the tool apparatus,
performing a machining operation with the tool apparatus without the assistance apparatus.

28. The method of claim 26, further comprising the steps of:
fastening a second assistance apparatus to the tool apparatus,
performing a machining operation with the tool apparatus with assistance from the assistance function of the second assistance apparatus.
